(19) United States
(12) Patent Application Publication
(10) Pub. No.: US 2008/0188671 A1
(43) Pub. Date: Aug. 7, 2008

(54) Method for Producing 2-Formylfuran-4-Boronic Acid by the Metalation of 4-Halofurfural Acetals in the Presence of Suitable Boronic Acid Esters or Anhydrides

(76) Inventors: Andreas Meudt, Hofheim (DE); Sven Nerdinger, Kiefersfelden (DE); Michael Erbes, Frankfurt am Main (DE); William Vogt, Kelkheim (DE)

Correspondence Address: PROPAT, L.L.C., 425-C SOUTH SHARON AMITY ROAD, CHARLOTTE, NC, 28211-2841, US

(21) Appl. No.: 11/912,157

(22) PCT Filed: May 10, 2006
(86) PCT No.: PCT/EP2006/000436

§ 371 Date: Oct. 22, 2007

(30) Foreign Application Priority Data
May 20, 2005 (DE) 10 2005 023 989.7

(51) Int. Cl. C07F 5/02

(52) U.S. Cl. 549/213

(57) ABSTRACT

Methods for producing furfural-4-boronic acid by the reaction of furfural acetals (I), which are substituted by halogen in position 4, with boronic acid esters or anhydrides, by the subsequent metalation of compound (I) and the simultaneous or subsequent reaction with a boronic acid ester or anhydride to form an acetal-protected furfural-4-boronic acid ester. This product is subjected to acid hydrolysis to form furfural-4-boronic acid. In the formulae: X represents chlorine, bromine or iodine; R represents a branched, unbranched and/or cyclic, optionally substituted C₁-C₂₀ alkyl group, an optionally substituted C₆-C₁₂ aryl group or an optionally substituted C₃-C₈ cycloalkyl group, the two groups R together can form a ring; R′, R″, R′″ independently of one another represent acylic or cyclic, branched or unbranched, optionally substituted C₁-C₂₀ alkyl groups, or optionally substituted aryl groups, optionally two of the groups R′, R″ and R′″ together form a ring, or represent additional groups B(OR)₃.

Method for producing 2-formylfuran-4-boronic acid by the metalation of 4-halofurfural acetals in the presence of suitable boronic acid esters or anhydrides

The invention relates to a process for preparing furfural-4-boronic acid (III) by reacting furfural acetals (I) which bear suitable halogens in the 4 position (X=Cl, Br, I) in the presence of boronic esters (II) with suitable organometallic compounds (Mg, Alk-MgX, Li, Alk-Li) with retention of regioselectivity (EQUATION 1).

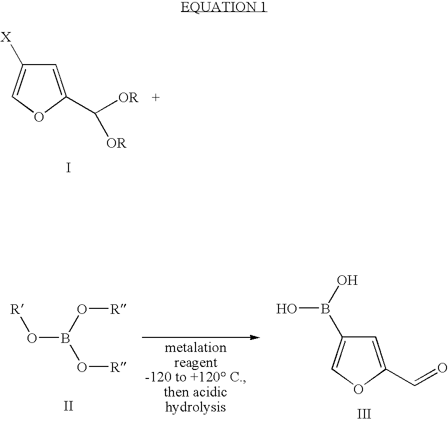

The growth of transition metal-catalyzed C—C couplings in the pharmaceutical and agrochemical sector in particular is being accompanied by a rising demand for aryl- and heteroarylboronic acids whose substitution patterns are becoming ever more complex. Especially furanylboronic acids which still bear functional groups on the furan ring occur very frequently in biologically active molecules or their chemical precursors. The significance in modern organic synthesis is restricted only by limitations in the availability of this compound class. This compound class is therefore obtainable in the chemical trade only in small amounts and at very high cost, which are an obstacle to use outside combinatorial active substance research.

It is therefore an object of the invention to find a process which, proceeding from 4-halo-substituted furfural acetals, enables the synthesis of the corresponding furfural-4-boronic acid, at the same time achieves very high yields and purities and is thus usable in economically utilizable processes. The synthesis process published to date for this purpose does not solve this problem and exhibits considerable disadvantages:
Very low yields and unspecified purities (Florentin et al., Bull. Soc. Chim., 1976, 1999-2005)
By-products are formed by rearrangement, for example furfural-5-boronic acid.

The present process solves this problem and relates to a process for preparing furfural-4-boronic acid (III) by reacting furfural acetals (I) which are halogen-substituted in the 4 position with boronic esters or anhydrides (II), by metalating the compound (I) with simultaneous or subsequent reaction with a boronic ester or anhydride (II) to give an acetal-protected furfural-4-boronic ester and subsequent acidic hydrolysis with elimination of the acetal protecting group to give furfural-4-boronic acid (III)

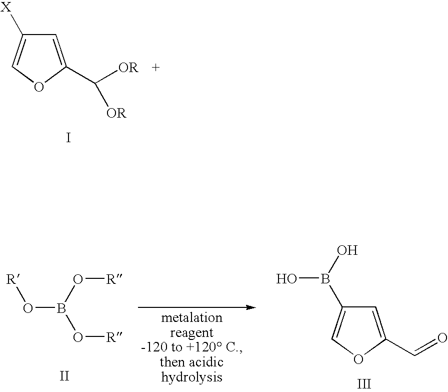

where
X is chlorine, bromine or iodine,
R is a branched, unbranched and/or cyclic, optionally substituted C₁-C₂₀, especially C₁-C₈ alkyl radical, an optionally substituted C₆-C₁₂ aryl radical or an optionally substituted C₃-C₈ cycloalkyl radical, where the two R radicals together may form a ring;
R′, R″, R″ are each independently acyclic or cyclic, branched or unbranched, optionally substituted C₁-C₂₀ alkyl groups, or optionally substituted aryl groups, where two of the R′, R″ and R′″ radicals together optionally form a ring, or are further B(OR)₃ radicals.
X is preferably chlorine, bromine or iodine, more preferably bromine in the case of metalation by halogen-metal exchange, more preferably chlorine in the case of lithiation with metallic lithium.
R′, R″ and R′″ are preferably alkyl radicals, especially linear or branched lower alkanes and cycloalkanes, preferably methyl, ethyl, propyl, butyl, isopropyl, isobutyl, tert-butyl, pentyl, isopentyl, neopentyl, cyclopentyl, hexyl, isohexyl, cyclohexyl, cycloheptyl, cyclooctyl, etc.

Protecting and deprotecting step are performed either in bulk or in a suitable solvent which is appropriate to the reaction. Useful protecting groups include, for example, imines, open-chain or cyclic thio- and dithio-acetals, oxazolidines and acetals. Particular preference is given to acetals. In this case, for example, the alcohol used for the acetalization would be a solvent appropriate to the reaction. A solvent appropriate to the deprotection reaction is typically an aqueous solvent or solvent mixture.

Useful metalating reagents include, for example, Grignard compounds, diorganomagnesium compounds, organolithium compounds, triorganomagnesium ate complexes or alkali metal diorganoamides. It is also possible to use combinations of organolithium compound and complexing agents, or combinations of organolithium compound and alkali metal alkoxide, and also the reactive metal itself, for example sodium, lithium, magnesium or zinc in suitable form, optionally in the presence of a catalyst.

Particularly preferred metalating reagents are secondary Grignard compounds such as isopropyl-, cyclo-hexyl- or cyclopentylmagnesium halides, and primary or secondary alkyllithium compounds such as butyllithium, hexyllithium or cyclohexyllithium, or metallic lithium or magnesium, optionally in the presence of a catalyst.

Useful catalysts are in principle all compounds which have the capability of transferring individual electrons (one electron transfer reagent), for example salts of many transition metals, for example iron, or fused polycyclic aromatics, for example anthracene or naphthalene or optionally substituted bi- or oligo-phenyls, for example bis(tert-butyl)biphenyl, biphenyl, 4,4′-di-tert-butylbiphenyl. Particular preference is given to using biphenyls in conjunction with lithium and anthracene derivatives or ferrocene in conjunction with magnesium. The concentration of such a catalyst may be between 0.0001 and 200 mol %; particular preference is given to concentrations of from 0.01 to 1 mol %.

The metalated furfural acetal obtained is reacted with from 0.8 to 10 equivalents, especially from 1.0 to 1.4 equivalents, of a triorganoborate (II), which may already be present in the reaction mixture during the metalation.

The metalation step of the process according to the invention is performed in one or more suitable organic solvent(s), preferably in an aliphatic, aromatic or ethereal solvent or mixtures of these solvents, more preferably in tetrahydrofuran, lower dialkyl ethers, glyme, diglyme, toluene, cyclohexane, pentane, hexane or heptane.

The furfural acetal (I) is either borylated in situ by the boron compound present in the reaction mixture or, after metalation, by addition of the appropriate boron compound to form a borate complex.

In the preferred embodiment as a one-step variant, the triorganoboric ester (III) which, in this case, should bear sterically demanding substituents may also be initially charged with the 4-halofurfural acetal (I), and the organometallic compound can be metered in slowly at low temperatures. The furyl-metal compound formed as an intermediate reacts immediately with the triorganoboric ester (II) present in the solution. The mixture is stirred until complete conversion while optionally heating.

The workup is effected generally under the customary aqueous conditions to obtain (III) as the boronic ester, boronic acid or boronic anhydride.

The temperature for the metalation step is typically in the range from −120° C. to +120° C.; particular preference is given to performance between 0° C. and 50° C. in the case of use of Grignard compounds, between −80° C. and −40° C. in the case of use of organolithium compounds. Owing to the moisture and oxygen sensitivity of the organometallic reagents and intermediates, the reaction is preferably performed under dry inert gas, such as nitrogen or argon.

Final hydrolysis of the reaction mixture affords furfural-4-boronic acid (III) in high yields and purities.

The proton source used for the hydrolysis may be water or aqueous solutions of salts, acids or bases or buffer solutions in suitable concentration known to those skilled in the art.

If the protecting group has not already been eliminated during the workup of the boronic acid derivative, the elimination is performed under precisely controlled conditions in a manner compatible with the boronate group, i.e. leads to a minimum degree of proto-deboronation. Optionally, the product (II) can be purified further by recrystallization.

Particular preference is given to the acidic elimination of acetal protecting groups at a temperature of <60° C. and a pH of approx. 1.5-4.0.

The 2-formylfuran-4-boronic acid thus obtained can be used without any problem in Suzuki couplings. For the first time, the process offers a simple inexpensive route to the synthesis of these compounds in good yields and very high purities.

One advantage of this process is the good availability of 2-formylfuran-4-boronic acid, which is obtainable only in poor yields by the known processes. A further advantage of the process according to the invention is that the purity of the product is very high (>99%, HPLC) and no products form by rearrangement. In the process according to the invention, the proportion of, for example 2-formylfuran-5-boronic acid, is, for example, <0.1% (HPLC). The furfural-4-boronic acid is obtained in yields of <60%.

The process according to the invention will be illustrated by the examples which follow without restricting the invention thereto:

### EXAMPLES

### Example 1

### Synthesis of 2-formylfuran-4-boronic Acid Proceeding from 4-bromo-2-diethoxymethylfuran in the Presence of Triisopropyl Borate with N-Butyllithium

With exclusion of air, 80.0 g of 4-bromofurfural diethyl acetal (145 mmol), 32.8 g of triisopropyl borate (173 mmol) are dissolved in 341 g of toluene and 81.3 g of THF at room temperature and then cooled to from −65 to −70° C. 70.0 ml of n-butyllithium (2.5 mol/l in n-hexane) are then added dropwise within 1.5 h at such a rate that the temperature does not exceed −65° C. and stirred further until the conversion is complete (by HPLC). The mixture is warmed to −40° C. and admixed with 119 g of MIBK (methyl isobutyl ketone). Subsequently, the low boilers are distilled off at 100 mbar and a maximum temperature in the bottom of 55° C. After cooling to room temperature, the black liquid residue is introduced into 193 g of ice-water (0-5° C.) (pH ˜12). Thereafter, the pH of the mixture is adjusted to from 0.8 to 1.5 with ˜16 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 24 g of cold MIBK, 2-formyfuran-4-boronic acid is obtained as a colorless powder which, after drying under reduced pressure at 40° C. under N₂, affords 15.1 g (91%).

### Example 2

### Synthesis of 2-formylfuran-4-boronic Acid Proceeding from 4-iodo-2-diethoxymethylfuran in the Presence of Triisopropyl Borate with N-Butyllithium

With exclusion of air, 40.0 g of 4-iodofurfural diethyl acetal (45.7 mmol), 10.3 g of triisopropyl borate (54.5 mmol) are dissolved in 170 g of toluene and 41.5 g of THF at room temperature and then cooled to from −65 to −70° C. 22.0 ml of n-butyllithium (2.5 mol/l in n-hexane) are then added dropwise within 1.5 h at such a rate that the temperature does not exceed −65° C. and stirred further until the conversion is complete (by HPLC). The mixture is warmed to −40° C. and admixed with 38 g of MIBK. Subsequently, the low boilers are distilled off at 100 mbar and a maximum temperature in the bottom of 55° C. After cooling to room temperature, the black liquid residue is introduced into 61 g of ice-water (0-5° C.) (pH ˜12). Thereafter, the pH of the mixture is adjusted to from 0.8 to 1.5 with ˜16 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 8 g of cold MIBK, 2-formylfuran-4-boronic acid is obtained as a colorless powder which, after drying under reduced pressure at 40° C. under N₂, affords 5.06 g (80%).

### Example 3

as Example 1, except that the reaction was performed with n-butyllithium at −100° C. The yield was 82%.

### Example 4

as Example 1, except that n-butyllithium was added dropwise at −65° C. within 3 h. The yield was 73%.

### Example 5

as Example 1, except that n-hexyllithium was used in place of n-butyllithium. The yield was 71%.

### Example 6

as Example 1, 4-bromofurfural dimethyl acetal was used in place of 4-bromofurfural diethyl acetal. The yield was 69%.

### Example 7

as Example 1, 2-(4-bromofuran-2-yl)-[1,3]dioxolane was used in place of 4-bromofurfural diethyl acetal. The yield was 76%.

### Example 8

as Example 1, except that the reaction was used with tributyl borate in place of triisopropyl borate. The yield was 65%.

### Example 9

as Example 1, except that the reaction was performed with xylene in place of toluene. The yield was 60%.

### Example 10

as Example 1, except that 260 g of toluene and 162 g of THF were used. The yield was 63%.

### Example 11

### Synthesis of 2-formylfuran-4-boronic Acid Proceeding from 4-bromo-2-diethoxymethylfuran by Bromine-Magnesium Exchange by Means of Isopropylmagnesium Bromide

With exclusion of air, 40.0 g of 4-bromofurfural diethyl acetal (72.5 mmol) and 16.4 g of triisopropyl borate (86.5 mmol) are dissolved in 210 g of THF at room temperature and then cooled to from −65 to −70° C. 107 ml (75 mmol) of an approx. 0.7 M solution of isopropylmagnesium bromide in tetrahydrofuran are then added dropwise within 1.5 h at such a rate that the temperature does not exceed −60° C., and the mixture is stirred at this temperature until the conversion is complete (by HPLC). The mixture is warmed to −40° C. and admixed with 60 g of MIBK. Subsequently, the low boilers are distilled off at 100 mbar and a maximum temperature in the bottom of 55° C. After cooling to room temperature, the black liquid residue is introduced into 96 g of ice-water (0-5° C.) (pH ˜12). Thereafter, the pH of the mixture is adjusted to from 0.8 to 1.5 with ˜10 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 13 g of cold MIBK, 2-formylfuran-4-boronic acid is obtained as a colorless powder which, after drying under reduced pressure at 40° C. under N₂, affords 7.4 g (73%).

### Example 12

### 2-Formylfuran-4-boronic Acid by Grignard Reaction of 4-bromo-2-diethoxymethylfuran

With exclusion of air, a mixture of 20.0 g of 4-bromo-furfural diethyl acetal (36.3 mmol) and 9.4 ml (40.8 mmol) of triisopropyl borate in 50 g of THF is metered gradually into a suspension of 0.99 g (41.1 mmol) of magnesium in 110 g of THF while boiling under reflux. The mixture is stirred under reflux for another 6 h until the conversion is complete (by HPLC). The mixture is admixed with 35 g of MIBK. Subsequently, the low boilers are distilled off at 100 mbar and a maximum temperature in the bottom of 55° C. After cooling to room temperature, the black liquid residue is introduced into 50 g of ice-water (0-5° C.) (pH ˜12). Thereafter, the pH of the mixture is adjusted to from 0.8 to 1.5 with ˜6 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 10 g of cold MIBK, 2-formylfuran-4-boronic acid is obtained as a colorless powder which, after drying under reduced pressure at 40° C. under N₂, affords 3.35 g (66%).

### Example 13

### Synthesis of 2-formylfuran-4-boronic acid Proceeding from 4-bromo-2-diethoxymethylfuran by Bromine-Metal Exchange by Means of Lithium Tributyl-Magnesate

With exclusion of air, 40.0 g of 4-bromofurfural diethyl acetal (72.5 mmol) and 16.4 g of triisopropyl borate (86.5 mmol) are dissolved in 100 g of THF at room temperature and slowly added dropwise to a solution, cooled to −70° C., of lithium tributyl-magnesate in THF/hexane (approx. 262 ml, 75 mmol) (prepared from butylmagnesium bromide solution in THF and butyllithium solution in hexane at 0° C.). The mixture is stirred at this temperature until the conversion is complete (by HPLC). The mixture is warmed to −40° C. and admixed with 60 g of MIBK. Subsequently, the low boilers are distilled off at 100 mbar and a maximum temperature in the bottom of 55° C. After cooling to room temperature, the black liquid residue is introduced into 96 g of ice-water (0-5° C.) (pH ˜12). Thereafter, the pH of the mixture is adjusted to from 0.8 to 1.5 with ˜10 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 13 g of cold MIBK, 2-formylfuran-4-boronic acid is obtained as a colorless powder which, after drying under reduced pressure at 40° C. under N₂, affords 7.7 g (76%).

### Example 14

### 2-Formylfuran-4-boronic Acid by Reaction of 4-chloro-2-diethoxymethylfuran with Elemental Lithium

A mixture of 20.0 g of 4-chlorofurfural diethyl acetal (30 mmol), 7.60 ml (34 mmol) of triisopropyl borate and a catalytic amount of biphenyl in 100 ml of tetra-hydrofuran is metered slowly at −70° C. into 460 mg (66 mmol) of lithium in 20 ml of tetrahydrofuran within 8 h and stirred between −50 and −40° C. for 24 h until the conversion is complete (by HPLC). The mixture is admixed with 35 g of MIBK. Subsequently, the low boilers are distilled off at 100 mbar and a maximum temperature in the bottom of 55° C. After cooling to room temperature, the black liquid residue is introduced into 50 g of ice-water (0-5° C.) (pH ˜12). Thereafter, the pH of the mixture is adjusted to from 0.8 to 1.5 with ˜6 g of HCl (15% strength). Within a 90 minute continued stirring phase at from 0 to 5° C., the 2-formylfuran-4-boronic acid precipitates out of the solution and is obtained by filtration with suction through needlefelt. After the precipitate has been washed with 10 g of cold MIBK, 2-formylfuran-4-boronic acid is obtained as a colorless powder which, after drying under reduced pressure at 40° C. under N₂, affords 3.09 g (61%).

1. A process for preparing furfural-4-boronic acid (III) comprising 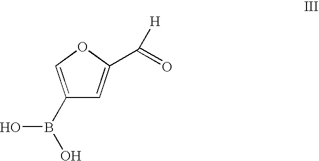
reacting furfural acetals (I) which are halogen-substituted in the 4 position with boronic esters or anhydrides (II), said process further comprising metalating the compound (I) with simultaneous reaction with a boronic ester or anhydride (II) to give an acetal-protected furfural-4-boronic ester and subsequent acidic hydrolysis with elimination of the acetal protecting group to give furfural-4-boronic acid (III) 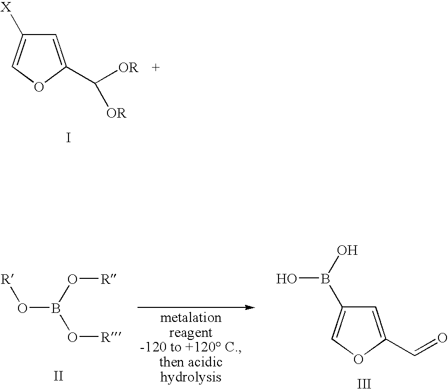
where
X is chlorine, bromine or iodine,
R is a branched, unbranched and/or cyclic, optionally substituted C₁-C₂₀ alkyl radical, an optionally substituted C₆-C₁₂ aryl radical or an optionally substituted C₃-C₈ cycloalkyl radical, where the two R radicals together may form a ring; R′, R″, R″ are each independently acyclic or cyclic, branched or unbranched, optionally substituted C₁-C₂₀ alkyl groups, or optionally substituted aryl groups, where two of the R′, R″ and R′″ radicals together optionally form a ring, or are further B(OR)₃ radicals.

2. The process as claimed in claim 1, wherein the metalation further comprises a metalating reagent and the metalating reagent used is an organolithium compound, an organomagnesium compound, a magnesiumate complex or an organo-magnesium compound in the presence of a salt, or a sufficiently reactive metal such as lithium, sodium, magnesium or zinc.

3. The process as claimed in claim 2, wherein the metalation with the metalating reagent is performed within a temperature range from −120 to +120° C.

4. The process as claimed in claim 1, wherein the metalation is performed in a solvent from the following group: triethylamine, diethyl ether, di-n-propyl ether, diisopropyl ether, dibutyl ether, tetrahydrofuran, 2-methyltetrahydrofuran, tert-butyl methyl ether, benzene, toluene, xylene, anisole, pentane, hexane, isohexane, heptane, petroleum ether (alkane mixtures), cyclohexane, methyl-cyclohexane, and solvent mixtures which comprise at least one of the above solvents.

5. The process as claimed in claim 1, wherein the metalation is performed in the presence of a catalyst.

6. The process as claimed in claim 5, wherein the catalyst is a one electron transfer reagent.

7. A process as claimed in claim 1, wherein 2-formyl-5-boronic acid is formed to an extent of <0.1% (HPLC).

8. The process as claimed in claim 7, wherein the metalation is performed in the presence of a catalyst and the catalyst is a one electron transfer reagent.

9. The process as claimed in claim 8, wherein 2-formyl-5-boronic acid is formed to an extent of <0.1% (HPLC).

10. The process as claimed in claim 1, wherein R is an optionally substituted C₁-C₈ alkyl radical.

11. The process as claimed in claim 6, wherein the catalyst used is naphthalene, anthracene, biphenyl, 4,4′-di-tert-butylbiphenyl or an iron salt.

12. The process as claimed in claim 8, wherein the catalyst is naphthalene, anthracene, biphenyl, 4,4′-di-tert-butylbiphenyl or an iron salt.
